(19) United States
(12) Patent Application Publication
(10) Pub. No.: US 2007/0189109 A1
(43) Pub. Date: Aug. 16, 2007

(54) IMPROVED VOLUMETRIC CEMENT MIXER

(75) Inventor: RICHARD L. LONG, Osceola, IA (US)

Correspondence Address: MCKEE, VOORHEES & SEASE, P.L.C., 801 GRAND AVENUE, SUITE 3200, DES MOINES, IA, 50309-2721, US

(73) Assignee: CEMEN TECH, INC., Indianola, IA (US)

(21) Appl. No.: 11/674,707

(22) Filed: Feb. 14, 2007

Related U.S. Application Data
(60) Provisional application No. 60/773,517, filed on Feb. 15, 2006.

(51) Int. Cl. B28C 5/18

(52) U.S. Cl. 366/42

(57) ABSTRACT

An improved volumetric cement mixer has bins, containers, and troughs formed from UHMW material reinforced with expanded metal. A metal skeletal frame supports the UHMW walls of the sand and gravel bins, while mininizing the weight of the mixer. The UHMW troughs for the boot mixer and discharge chute improve product flow and mixing, and simplifies cleaning of the troughs.

### CROSS-REFERENCE TO RELATED APPLICATIONS

This application claims priority under 35 U.S.C. § 119 of a provisional application Ser. No. 60/773,517 filed Feb. 15, 2006, which application is hereby incorporated by reference in its entirety.

### BACKGROUND OF THE INVENTION

Generally, there are two types of cement mixing systems used in the cement industry, a continuous volumetric mixer, or a batch ready mix mixer. A volumetric mixer normally includes separate bins for holding the sand, aggregate, and Portland cement which are discharged onto a conveyor and transported in a dry state to a mixing boot or chute wherein water is added to form the concrete mix. In comparison, a ready mix mixer, such as a cement truck, includes a rotating drum or tank wherein the sand, aggregate, Portland cement, and water are mixed before discharge into a chute. A volumetric mixer is normally stationed at the job site, wherein the ingredients are loaded into the respective mixer bins, whereas a ready mix mixer travels to the job site as the ingredients are mixed.

Prior art volumetric mixer bins normally are constructed of steel. Stainless steel bins are also known, though are much more costly than steel bins. A major problem with steel bins is rusting, caused by the corrosive nature of sand, limestone, other aggregates, and Portland cement. Rusting in the bin leads to reduced product flow and bridging. Therefore, the prior art volumetric mixer bins include vibrators to prevent bridging and maintain product flow.

A primary objective of the present application is the provision of an improved volumetric mixer which overcomes the problems of the prior art.

Another objective of the present application is the provision of a volumetric cement mixer having non-corrosive bins.

Still another objective of the present application is the provision of an improved volumetric cement mixer having bins which maintain product flow and prevent bridging of product within the bins, without the use of vibrators.

A further objective of the present application is the provision of an improved volumetric cement mixer having reinforced plastic bins, mixing boot, and discharge chute.

Yet another objective of the present application is the provision of an improved volumetric cement mixer having bins and a mixing boot made from UHMW plastic with expanded metal imbedded therein.

A further objective of the present application is the provision of an improved volumetric cement mixer having bins, a mixing boot, and discharge chute which are strong, lightweight, and durable in use.

These and other objectives will become apparent from the following description of the invention.

### BRIEF SUMMARY OF THE INVENTION

The present invention is directed towards an improved volumetric cement mixer. The mixer includes multiple bins for the concrete ingredients, including a sand bin, an aggregate bin, and a Portland cement bin. The bins may be formed as a large container with dividing walls or as separate independent bins. The walls of the bin are made from reinforced plastic, which preferably includes expanded metal bonded between two layers of ultra high molecular weight (UHMW) plastic. The bins are supported by a metal skeletal frame so as to provide a strong, yet lightweight structure for the storage of the concrete ingredients.

The mixer also includes a mixing boot wherein the ingredients are mixed with water and a discharge chute. Preferably, the mixing boot and discharge chute are also made of the same reinforced material having expanded metal sandwiched between two layers of UHMW plastic.

The reinforced plastic has a lower coefficient of friction than steel or stainless steel conventionally used in cement mixers. Therefore, the reinforced plastic eliminates bridging problems in the bins, reduces the power requirements for mixing and discharge, and simplifies clean up.

### BRIEF DESCRIPTION OF THE DRAWINGS

FIG. 1 is a side elevation view of one embodiment of the volumetric cement mixer of the present invention.

FIG. 2 is a perspective schematic of the sand and aggregate bins of the mixer according to the present invention.

FIG. 3 is a top plan schematic of the sand and aggregate bins of the mixer.

FIG. 4 is a sectional view taken along lines 4-4 of FIG. 2.

FIG. 5 is an end view of the mixer boot, which is similar to an end view of the discharge chute, showing the UHMW reinforced plastic used in the cement mixer according to the present invention.

### DETAILED DESCRIPTION OF EXEMPLARY EMBODIMENTS

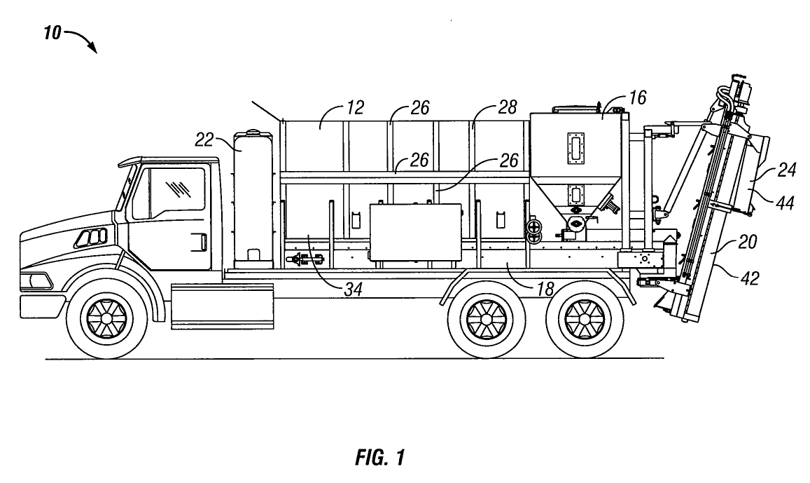

The volumetric cement mixer is generally designated in FIG. 1 by the reference numeral 10. The cement mixer 10 is shown to be mounted on a truck chassis so as to be portable. However, it is understood that the volumetric cement mixer of the present invention may also be built at or transported to a job site and set on the ground or other support structure so as to be non-portable.

The cement mixer 10 includes a pair of bins 12, 14 for holding sand and gravel or other aggregate, as well as a separate container or bin 16 for storing Portland cement. The bins 12, 14 and container 16 are positioned above a conveyor 18 for receiving the concrete ingredients or materials from the bins 12, 14 and container 16. The conveyor 18 discharges the sand, gravel and Portland cement into a mixer boot 20. A water tank 22 supplies water to the mixer boot 20. An auger (not shown) resides within the mixer boot 20, and is driven by any convenient means so as to mix the sand, gravel, cement, and water within the boot 20. When mixing is complete, the wet concrete is expelled through and outlet chute 24 on the end of the boot 20.

The walls of the bins 12, 14 are made from reinforced ultra high molecular weight (UHMW) plastic. More particularly, the walls of the bins 12, 14 include two layers of UHMW plastic with expanded metal embedded therein so as to provide structural support to the walls. The expanded metal also minimizes thermal effects on the UHMW material, such as shrinkage in cold weather and expansion in hot weather. The reinforced UHMW walls are supported by a metal skeletal frame 26. The frame 26 provides structural integrity to the bins 12, 14 while minimizing the weight of the mixer 10.

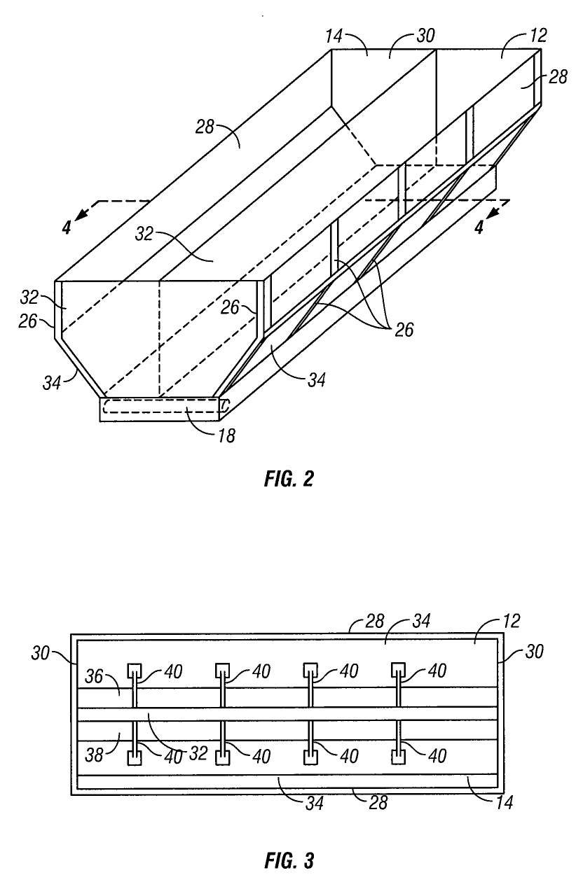

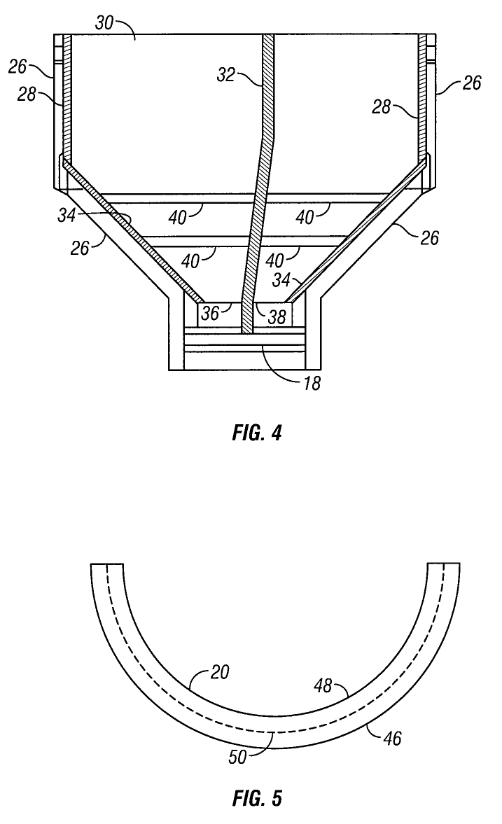

As seen in FIG. 2, the bins 12, 14 may be formed from an enlarged container having opposite side walls 28, opposite end walls 30, and a central dividing wall 32. Preferably, the side walls 28 included lower sloped portions 34 which allow the sand and gravel to flow by gravity through lower openings 36, 38 into the conveyor 18. As seen in FIG. 3, support braces 40 extend between the central dividing wall 32 and the opposite side walls 28.

As an alternative construction, the bins 12, 14 can be formed separately from one another, with each bin having its own perimeter walls.

The reinforced UHMW walls with embedded expanded metal may also be used as the walls of the Portland cement container 16. Furthermore, the lower troughs 42, 44 of the mixer boot 20 and discharge chute 24 are preferably made of similar UHMW material layers with expanded metal sandwiched therein. As seen in FIG. 5, the reinforced material is preferably formed from an outer plastic layer 46, and inner plastic layer 48 and a sheet of expanded metal 50 embedded between the layers 46 and 48 and bonded thereto. The openings in the expanded metal facilitate bonding of the UHMW plastic to the embedded metal. It is understood that the reinforced walls 28, 30, 32 have a similar structure as shown in FIG. 5, though flat or planar, rather than curved.

The reinforced UHMW walls 28, 30 and 32 of the bins 12, 14 minimizes or eliminates bridging of material within the bins, and eliminates the need for vibrators for breaking up such bridge product bridging. The plastic surface of the UHMW material used for the bins 12, 14, container 16, boot trough 42, and discharge chute trough 44 is not subject to corrosion and simplifiers cleanup of the surfaces of the cement mixer 10. The reduced coefficient of friction of the plastic surface also minimizes the auger horse power requirements in the mixing boot 20, since the mixture moves or flows more readily through the boot, as compared to the prior art boots. The embedded expanded metal in the reinforced UHMW material provides additional rigidity for the boot trough 42, as compared to prior art rubber boots, and thus provides for more uniform mixing of the ingredients by the auger.

Thus, the improved volumetric cement mixer of the present invention accomplishes at least all of the stated objectives.

What is claimed is:

1. An improved volumetric cement mixer, comprising:
a first bin for sand;
a second bin for aggregate; and
a third bin for cement;
at least one of the bins being made of reinforced plastic material.

2. The cement mixer of claim 1 wherein the reinforced plastic material includes expanded metal bonded between two layers of ultra high molecular weight plastic.

3. The cement mixer of claim 1 further comprising a skeletal frame for supporting the bins.

4. The cement mixer of claim 1 wherein the bins are free from mechanical vibrators.

5. The cement mixer of claim 1 further comprising a mixing boot made of the reinforced plastic material.

6. The cement mixer of claim 5 wherein the plastic material in the boot includes expanded metal bonded between two layers of ultra high weight molecular weight plastic.

7. The cement mixer of claim 1 further comprising a discharge chute made of the reinforced plastic material.

8. The cement mixer of claim 7 wherein the plastic material in the chute includes expanded metal bonded between two layers of ultra high weight molecular weight plastic.

9. The cement mixer of claim 1 wherein the bins are seamless.

10. The cement mixer of claim 1 wherein first, second and third bins are formed as a large container with a dividing wall defining the bins.

11. The cement mixer of claim 1 wherein the first, second and third binds are formed separately from one another.

12. An improved volumetric cement mixer having ingredient bins, a mixing boot, and a discharge chute all defining support surfaces for the material in the bins, boot and chute, the improvement comprising:
at least some of the support surfaces being formed with reinforced plastic.

13. The cement mixer of claim 12 wherein the reinforced plastic includes two layers of UHMW material with expanded metal sandwiched between the two layers.

14. The cement mixer of claim 12 further comprising a skeletal frame for supporting the bins.

15. The cement mixer of claim 12 wherein the bins are free from mechanical vibrators.

16. The cement mixer of claim 12 wherein all the support surfaces are made of reinforced plastic.

17. The cement mixer of claim 12 wherein first, second and third bins are formed as a large container with a dividing wall defining the bins.

18. The cement mixer of claim 12 wherein the first, second and third binds are formed separately from one another.

19. An improved volumetric cement mixer having ingredient bins, a mixing boot, and a discharge chute all defining support surfaces for the material in the bins, boot and chute, the improvement comprising:
substantially all the support surfaces in the bins, boots and chute being made of reinforced plastic.

20. The cement mixer of claim 19 wherein the reinforced plastic includes two layers of UHMW material with expanded metal sandwiched between the two layers.
